(19) United States
(12) Patent Application Publication
(10) Pub. No.: US 2007/0102024 A1
(43) Pub. Date: May 10, 2007

(54) Domestic machine comprising a system for feeding a cleaning product into the cleaning liquid

(75) Inventor: Eghert Classen, Wertingen (DE)

Correspondence Address: Russell Warnock, BSH Home Appliances Corp, 100 Bosch Blvd., New Bern, NC, 28562, US

(73) Assignee: BSH Bosch and Siemens Haugeräte, GmbH, Munich (DE)

(21) Appl. No.: 10/575,613

(22) PCT Filed: Oct. 13, 2004
(86) PCT No.: PCT/EP04/52530

§ 371 Date: Apr. 11, 2006

(30) Foreign Application Priority Data
Oct. 14, 2003 (DE) 10347766.7

(51) Int. Cl. B08B 7/04; B08B 3/00

(52) U.S. Cl. 134/18; 134/56 R; 134/56 D; 134/58 R; 134/58 D

(57) ABSTRACT

A dishwasher machine or washing machine includes a device that takes into account the loaded state of the machine or the type of dirtiness of the items to be washed, in order to be able to determine and regulate the amount of washing-active substances required in the cleaning liquid for optimum cleaning effect. To this end, water-bearing appliance is provided with a system for feeding a cleaning product into the cleaning liquid, a sensor determines the content of washing-active substances in the cleaning liquid during the cleaning process, and a dosing device feeds an additional cleaning product into the cleaning liquid when the content of washing-active substances in the cleaning liquid is too low, or fresh water when the content of washing-active substances in the cleaning liquid is too high.

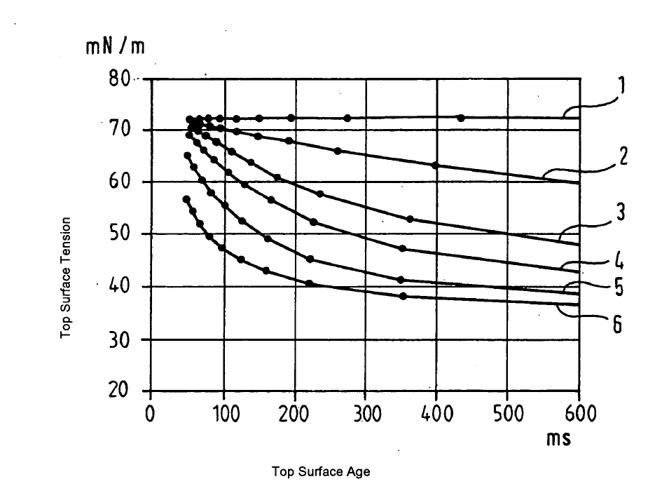

The present invention relates to a domestic machine such as a dishwasher or washing machine, for example, comprising a system for supplying cleaning product into the cleaning liquid and a method for operating the same.

Usually in the course of the cleaning program in a washing machine or dishwasher, one or more cleaning processes are carried out in the course of the cleaning program, wherein the washing solution or the rinsing solution is mixed with washing-active substances to improve the cleaning result. In dishwashers the final rinsing process is usually followed by a clear rinse phase in which the rinsing solution is mixed with a rinse aid. So far, however, in the aforesaid domestic appliances a fixedly pre-determined amount of washing or rinsing agents is added to the cleaning liquid.

In numerous cleaning process, tensides are frequently used as washing-active substances which have the property of lowering the surface tension of liquids and thus enhancing the cleaning effect. The washing-active efficiency of tensides depends to a great extent on their concentration. With increasing tenside content, for example, the surface tension of the solution decreases sharply until after a certain limit specific to the substance has been exceeded, saturation occurs so that a further increase in concentration only causes slight changes in the surface tension of the solution. The magnitude of this limit depends on many factors including the temperature, the content of organic substances or ions in the solution. At a lower tenside concentration, the intended cleaning effect is reduced; an increase above the optimal amount however brings about economic and ecological disadvantages.

The metering of tensides in the cleaning liquid is generally effected by adding an empirical or prescribed quantity. When calculating the optimal tenside concentration, the dependence of the cleaning effect on many factors such as, for example, temperature, hardness of the water, degree of contamination and type of contamination, should be taken into account. For cleaning purposes a considerably increased dosage is frequently used to compensate for the consumption of tensides which bind to contaminants. Furthermore, particularly in the domestic area, there are considerable deviations from the optimal dosage of cleaning agents in water-bearing domestic appliances. In this case, in dishwashers for example, the cleaning agent is poured into a container of a cleaning agent dispenser provided for this purpose before the beginning of the washing program (in a commercially available domestic dishwasher about 25 g per cleaning process) and during the washing operation is emptied completely into the cleaning liquid by the program control.

This has the disadvantage that during the washing or rinsing process the quantity of washing or rinsing agent poured into the dishwasher by the user is completely used and consumed without taking into account the quantity of washing and rinsing agent actually required. Dishwashers are known in which the water hardness of the cleaning liquid is determined by suitable sensors to determine the amount of rinse aid added at the end of the rinsing program. However, other crucial criteria for the quantity of cleaning agent required, such as for example, the loading state of the dishwasher or the type of contamination of the items to be cleaned are not taken into account.

It is the object of the present invention to eliminate the aforesaid disadvantages and provide a dishwasher or washing machine with a device which takes into account the loading state of the dishwasher or the type of contamination of the items to be washed or rinsed in order to determine and regulate the amount of washing-active substances in the cleaning liquid required for an optimal cleaning effect.

This object is solved by the domestic appliance according to the invention with the features according to claim 1 and by a method with the features according to claim 6. Advantageous further developments of the present invention are characterised in the dependent claims 2 to 4 and 6 to 10.

In the domestic machine according to the invention which is suitable for carrying out at least one cleaning process using cleaning liquid, a system for supplying cleaning agent into the cleaning liquid is provided, comprising a sensor which determines the content of washing-active substances in the cleaning liquid during the cleaning process and a dosing device which supplies additional cleaning agent to the cleaning liquid if the content of washing-active substances is too low or supplies fresh water to the cleaning liquid if the content of washing-active substances is too high. In this way, all criteria which influence the required quantity of washing-active substances in the cleaning liquid, such as the loading state of the domestic machine, for example, or the type of contamination of the items to be washed or rinsed, can be taken into account to determine and adjust the amount of washing-active substances required in the cleaning liquid for an optimal cleaning effect.

As described above, both under-dosing and over-dosing of the washing-active substances is disadvantageous for the cleaning result of the system. A knowledge of the content of washing-active substances in the washing solution or rinsing solution is thus of fundamental importance for the optimal cleaning cycle and saving of resources in washing machines and dishwashers. This defines crucial quantities such as the duration of the washing or rinsing program, the cleaning performance, the consumption of resources and environmental influences.

The domestic machine according to the invention has the advantage that the content of washing-active substances in the cleaning liquid is determined continuously during the cleaning process and on this basis the addition of cleaning agents to the cleaning liquid is regulated independently of influences such as the degree of contamination, temperature and water hardness in order to achieve the optimal content of washing active substances in the cleaning liquid. Thus both under-dosing with inadequate cleaning effect and also over-dosing with negative economical and ecological consequences can be avoided. In this way, on the one hand the duration of the washing or rinsing program, the cleaning performance and the consumption of resources are optimised and on the other hand, the environmental influences are minimised.

By using a sensor according to the invention for continuously determining the content of washing-active substances, the required quantity of cleaning agent can be determined regardless of the various active substances and therefore independently of the manufacturer of the cleaning agent and can be optimally metered. This effect is obtained from the function of the sensor which exclusively determines the concentration of washing-active substances in the cleaning liquid. This effect is especially advantageous in combination with the use of an automatic dosing system which can accommodate a quantity of cleaning agent sufficient for a plurality of cleaning processes. During the cleaning process the automatic dosing system only delivers the quantity of cleaning agent required on the basis of the content of washing-active substances determined by the sensor to the cleaning liquid.

In a preferred embodiment of the present invention, the quantity of cleaning agent delivered to the cleaning liquid during a cleaning process is only a fraction of the volume of cleaning liquid which can be stored in the dosing device. It is therefore no longer necessary to re-fill the supply container of the dosing device every time before a cleaning cycle is started. Instead, the storage container of the dosing device can be filled merely after a number of cleaning cycles when all the cleaning agent stored in the storage container of the dosing device has been used up.

Over the running time of the cleaning cycle, the concentration of washing-active substances can vary depending on the type and quantity of (residual) contamination of the items to be washed or rinsed. On the basis of continuous measurements of washing-active substances in the cleaning liquid, conclusions can thus be drawn regarding the type and intensity of the (residual) contamination of the items to be washed or rinsed. The concentration of the washing-active substances can be immediately adapted by means of the automatic dosing device either by supplying a certain volume of additional cleaning agent to the cleaning liquid or by supplying a certain volume of fresh water.

A simple, dynamic measuring system for determining the content of washing-active substances (wetting agents or tensides) in the cleaning liquid is a tensiometer, for example. The tensiometer generates a signal proportional to the surface tension of the cleaning liquid using the so-called bubble pressure method which corresponds to the tenside content in the cleaning liquid. A tensiometer operating according to the bubble pressure method (bubble tensiometer) comprises at least one capillary which passes into the cleaning liquid and from which a pre-determined gas flow escapes into the liquid at a pre-determined capillary pressure, forming bubbles. The gas used is usually air although in principle other gases can also be used. In this case, tensides contained in the cleaning liquid attach to the surface of an air bubble pressed through a measuring capillary into the cleaning liquid and thereby reduce the surface tension of the air bubble. Therefore, the higher the content of tensides or washing-active substances in the cleaning liquid, the lower is the surface tension of the air bubble. Since the measurement effect is reversible within the scope of the measuring accuracy, a falling concentration of tensides in the cleaning liquid for example during washing processes can also be detected by the bubble pressure method.

At the same time, it should be borne in mind that the surface tension of the air bubble varies depending on the time after formation of the air bubble. The appended drawings show a diagram where the profile of the surface tension of an air bubble pressed into the cleaning liquid in the manner described varies as a function of the surface age. The surface age of 0 to 600 ms is plotted on the x-axis of the diagram whilst the y-axis of the diagram gives the surface tension of 20 to 80 mN/m. A total of six curves are shown in the diagram, relating to different concentrations of tensides or washing-active substances in the cleaning liquid. The uppermost curve 1 relates to a measurement of the surface tension of an air bubble immersed in pure water without any cleaning agent added which consequently has a tenside content of 0 ml/l. Curve 2 relates to a tenside content of 1 ml/l in the cleaning liquid, curve 3 relates to a tenside content of 2 ml/l in the cleaning liquid, curve 4 relates to a tenside content of 3 ml/l in the cleaning liquid, curve 5 relates to a tenside content of 5 ml/l in the cleaning liquid and curve 6 relates to a tenside content of 10 ml/l in the cleaning liquid.

It can be deduced from the curves plotted in the diagram that a higher concentration of tensides or washing-active substances in the cleaning liquid reduces the surface tension of an air bubble immersed in the cleaning liquid. Whereas, for example, a tenside content of 1 ml/l causes a surface tension of the air bubble immersed in the cleaning liquid of about 70 mN/m at a surface age of 100 ms up to about 70 mN/m at a surface age of 600 ms, the surface tension of an air bubble immersed in the cleaning liquid having a tenside content of 10 ml/l is reduced from about 48 mN/m at a surface age of 100 ms to about 37 mN/m at a surface age of 600 ms.

As can be deduced from the curves plotted in the diagrams, the measurement of the surface tension by means of the bubble pressure method described above has the advantage that as a result of the flat profile of the surface tension as a function of the surface age, the surface tension of the air bubble immersed in the cleaning liquid and therefore the content of tensides or washing-active substances in the cleaning liquid can be determined reliably and relatively independently of time. Another advantage of the bubble pressure method is that the surface tension measured at the air bubble is largely independent of its immersion depth in the cleaning liquid. The determination of the content of washing-active substances in the cleaning liquid by means of a tensiometer using the bubble pressure method is suitable for optimising the rinsing or washing programs of dishwashers and washing machines by determined the tenside content in the cleaning liquid according to the present invention and correcting if necessary.

In a domestic machine according to the present invention the content of washing-active substances (wetting agents or tensides) in the cleaning liquid during the cleaning phase is determined by means of a suitable sensor, preferably a tensiometer or tenside sensor. This content of washing-active substances in the cleaning liquid determined by the tenside sensor is used to optimise the content of washing-active substances in the cleaning liquid, for example, by mixing the cleaning liquid with additional cleaning agent as required or by supplying further fresh water to the cleaning liquid already present in the domestic machine to reduce the concentration of washing-active substances in the cleaning liquid. The evaluation of the signals delivered by the tenside sensor and the evaluation of the content of washing-active substances in the cleaning liquid and the following regulation of the supply of cleaning agent and/or fresh water is preferably undertaken by an electronic control system. However, it is also possible to display the content of washing-active substances in the cleaning liquid determined by the sensor during cleaning operation by means of a suitable display means, optionally supported by an acoustic signal, and the operator automatically adds cleaning agents during the cleaning operation on the basis of the indicated concentration.

The principle forming the basis of the present invention consequently consists in continuously determining the content of washing-active substances in the cleaning liquid during the cleaning process. In some water-bearing domestic machines various automatic functions are already known, such as for example the automatic sequence control of the washing program in dishwashers by an electronic control system or the automatic regulation of the temperature of the cleaning liquid. According to the teaching of the present invention it is now also possible to monitor and automatically regulate the content of washing-active substances during the cleaning phase.

In an advantageous embodiment of the present invention, the content of washing-active substances in the cleaning liquid is determined continuously or at least at short time intervals during the cleaning process. In this case, the sensor to determine the content of washing-active substances in the domestic machine should preferably be arranged so that it is surrounded by cleaning liquid as continuously as possible during the cleaning process. The content of washing-active substances during the cleaning process can thus be monitored immediately and the system can respond rapidly to fluctuations in concentration. The reaction time for correcting the content of washing-active substances in the cleaning liquid can be further increased if the system for supplying cleaning agent to the cleaning liquid as a function of the content of washing-active substances in the cleaning liquid determined by the sensor is regulated by means of an electronic control system. Furthermore, the content of washing-active substances in the cleaning liquid can also be determined from the signal delivered by the sensor by means of electronic means.

In an advantageous embodiment of the present invention, the cleaning process itself is regulated as a function of the content of washing-active substances in the cleaning liquid determined by the sensor. At the same time, it can be provided, for example that at least some of the cleaning process is repeated depending on the content of washing-active substances in the cleaning liquid determined by the sensor. It is thereby possible for the cleaning process to be repeated or extended if it is ascertained by determining the content of washing-active substances in the cleaning liquid or their time behaviour that the contamination of the items to be washed or rinsed requires a more intensive cleaning process.

Additionally or alternatively it can also be provided that at least part of the cleaning process is omitted or interrupted depending on the content of washing-active substances in the cleaning liquid determined by the sensor. It is thereby possible for the cleaning process to be shortened or prematurely interrupted if it is ascertained by determining the content of washing-active substances in the cleaning liquid or their time behaviour that the contamination of the items to be washed or rinsed is low and requires only a short cleaning process.

1-10. (canceled)

11. An appliance operable to carry out at least one cleaning process using cleaning liquid, the appliance comprising:
an assembly for disposing a cleaning liquid and at least one item to be cleaned into contact with one another; and
a system for supplying cleaning agent into the cleaning liquid, the system including a sensor that determines the content of washing-active substances in the cleaning liquid during the cleaning process and a dosing device that alternately supplies additional cleaning agent to the cleaning liquid in the event that the sensed content of washing-active substances is below a predetermined lower value and supplies fresh water to the cleaning liquid in the event that the content of washing-active substances is above a predetermined upper value.

12. The appliance according to claim 11, wherein the system for supplying cleaning agent to the cleaning liquid is regulated as a function of the content of washing-active substances in the cleaning liquid determined by the sensor by means of an electronic control.

13. The appliance according to claim 11, wherein the sensor is a tenside sensor that determines the content of tensides in the cleaning liquid by means of the bubble pressure method.

14. The appliance according to claim 13, wherein the tenside sensor in the appliance disposed to be surrounded by cleaning liquid as continuously as possible during the cleaning process.

15. A method for operating an appliance operable to carry out at least one cleaning process using cleaning liquid, the method comprising the steps of:
determining the content in a cleaning liquid of washing-active substances that are supplied thereinto via the supply of cleaning agent into the cleaning liquid by a cleaning agent supply system;
supplying additional cleaning agent to the cleaning liquid in the event that the content of washing-active substances is determined to be below a predetermined lower value; and
supplying fresh water to the cleaning liquid in the event that the content of washing-active substances is determined to be above a predetermined upper value.

16. The method for operating an appliance according to claim 15, wherein the content of washing-active substances in the cleaning liquid is determined by a selected one of continuously determining the content of washing-active substances in the cleaning liquid and determining the content of washing-active substances in the cleaning liquid at short time intervals.

17. The method for operating an appliance according to claim 15, wherein determining the content of washing-active substances in the cleaning liquid includes determining the content of washing-active substances in the cleaning liquid via electronic means.

18. A method for operating an appliance according to claim 15, wherein determining the content of washing-active substances in the cleaning liquid includes determining the content of washing-active substances in the cleaning liquid via a sensor.

19. The method for operating an appliance according to claim 18, wherein at least part of the cleaning process is repeated depending on the content of washing-active substances in the cleaning liquid via the sensor.

20. The method for operating an appliance according to claim 18, wherein a selected one of omission of at least part of the cleaning process and interruption of at least part of the cleaning process is undertaken depending on the content of washing-active substances in the cleaning liquid determined by the sensor.
